(19) United States
(12) Patent Application Publication
(10) Pub. No.: US 2026/0084064 A1
(43) Pub. Date: Mar. 26, 2026

(54) SHOOTING GAME DEVICE BASED ON IMAGE DETECTION

(71) Applicant: REALTEK SEMICONDUCTOR CORPORATION, HSINCHU (TW)

(72) Inventors: CHANG-QING XIE, Suzhou (CN); JIANG-TAO NIE, Suzhou (CN); CHIA-CHI LEE, HSINCHU (TW)

(21) Appl. No.: 19/332,354

(22) Filed: Sep. 18, 2025

(30) Foreign Application Priority Data
Sep. 23, 2024 (CN) 202411320399.1

(51) Int. Cl. A63F 13/837; A63F 13/219; A63F 13/245; A63F 13/46

(52) U.S. Cl. CPC A63F 13/837; A63F 13/219; A63F 13/245; A63F 13/46

(57) ABSTRACT

A shooting game device includes a trigger device, an image sensor circuit, and an image detection circuit. The trigger device is configured to emit a trigger signal. The image sensor circuit is configured to capture image data of a target image in response to the trigger signal. The image detection circuit is configured to determine a game score according to brightness information of the image data.

### BACKGROUND OF THE INVENTION

### 1. Field of the Invention

The present disclosure relates to a shooting game device, and more particularly to a shooting game device based on image detection.

### 2. Description of Related Art

Existing shooting toys often use physical bullets for shooting, which results in lower game safety. Even toy guns using infrared beams may still pose a risk to the human eye. On the other hand, conventional shooting toys often require a larger number of sensors to detect whether the user has fired, and take more time to determine the game score, which leads to higher overall costs and poorer user experience.

### SUMMARY OF THE INVENTION

In some aspects of the present disclosure, an object of the present disclosure is, but not limited to, provide a shooting game device based on image detection that provides multiple manipulation ways for gaming, in order to make an improvement to the prior art.

In some aspects of the present disclosure, a shooting game device includes a trigger device, an image sensor circuit, and an image detection circuit. The trigger device is configured to emit a trigger signal. The image sensor circuit is configured to capture image data of a target image in response to the trigger signal. The image detection circuit is configured to determine a game score according to brightness information of the image data.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a shooting game device according to some embodiments of the present disclosure.

FIG. 2 illustrates a schematic external view of the shooting game device in FIG. 1 according to some embodiments of the present disclosure.

FIG. 3 illustrates a flowchart illustrating operations of the shooting game device in FIG. 1 according to some embodiments of the present disclosure.

FIG. 4A illustrates a flowchart illustrating the operations of the image detection circuit in determining the game score according to some embodiments of the present disclosure.

FIG. 4B illustrates a schematic diagram of the image data in FIG. 1 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with at least one circuit, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

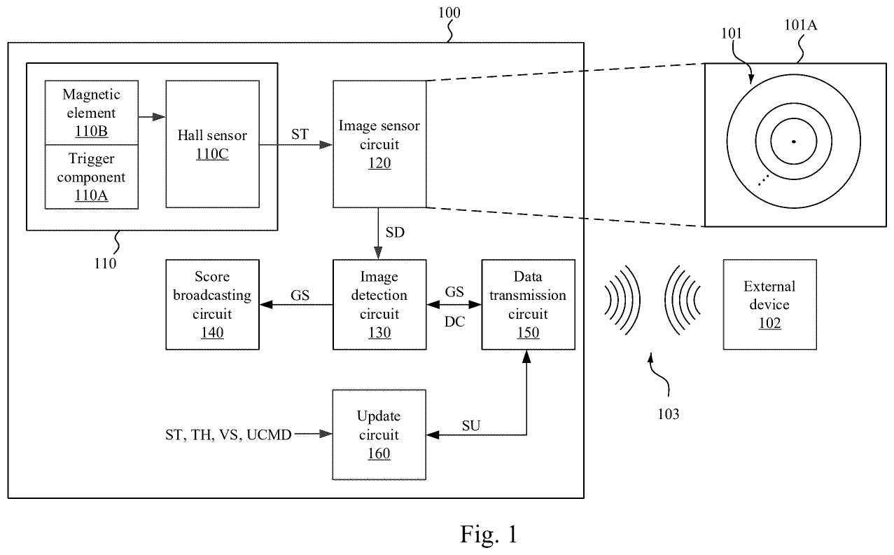

FIG. 1 illustrates a schematic diagram of a shooting game device 100 according to some embodiments of the present disclosure. The shooting game device 100 may use an image detection to determine a game score GS. The shooting game device 100 includes a trigger device 110, an image sensor circuit 120, an image detection circuit 130, a score broadcasting circuit 140, a data transmission circuit 150, and an update circuit 160.

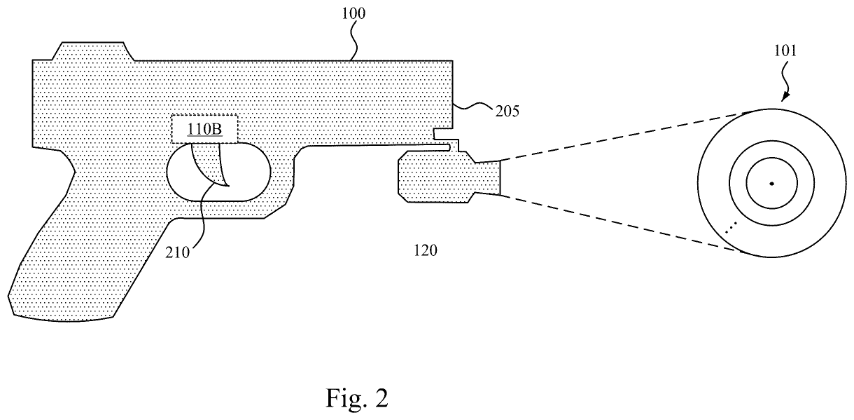

The trigger device 110 is configured to emit a trigger signal ST (equivalent to performing a shot) in response to a user operation. In some embodiments, the trigger device 110 may generate the trigger signal ST by causing a magnetic field variation. For example, the trigger device 110 may include a trigger component 110A (such as the trigger 210 in FIG. 2), a magnetic element 110B, and a Hall sensor 110C. The magnetic element 110B may be arranged on the trigger component 110A such that movement of the trigger component 110A, caused by the user's operation, induces a change in the magnetic field. Accordingly, the Hall sensor 110C may generate the trigger signal ST according to the magnetic field variation of the magnetic element 110B when the trigger component 110A moves. In some embodiments, the Hall sensor 110C may be arranged at an initial predetermined position of the trigger component 110A (e.g., a rest position when not actuated by the user), in order to generate the trigger signal ST when the trigger component 110A moves. With this configuration, only one Hall sensor may be employed in the trigger device 110.

The image sensor circuit 120 is configured to capture image data SD of a target image 101 in response to the trigger signal ST. In other words, in some embodiments of the present disclosure, the shooting game device 100 performs the shooting game using optical and image detection methods, rather than firing a physical object (e.g., bullets, arrows, etc.) at the target image 101. As a result, the game may maintain playability while enhancing game safety.

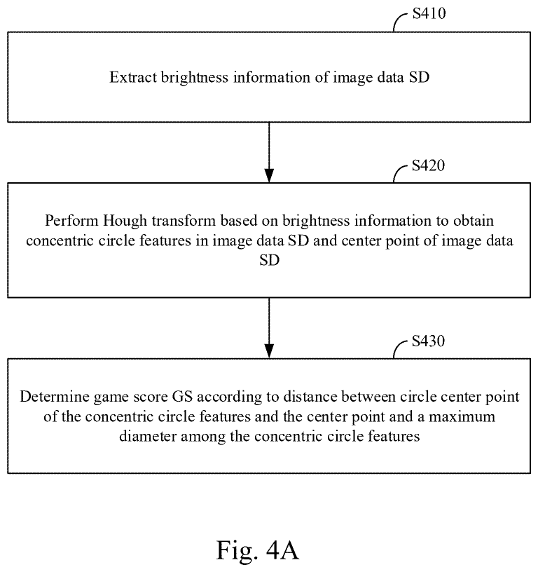

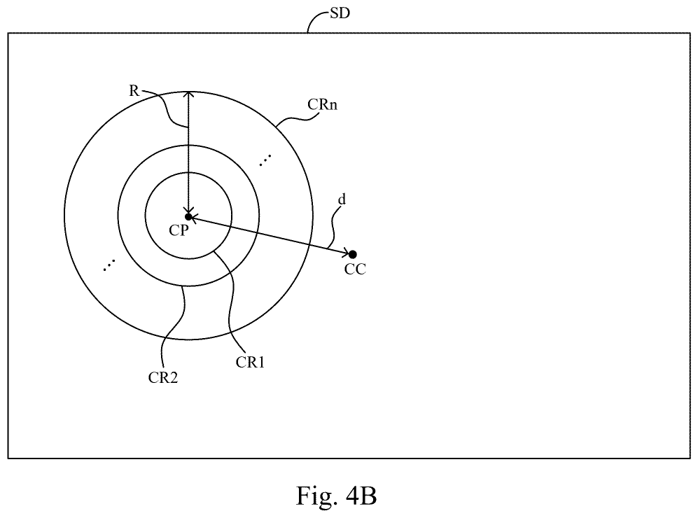

The image detection circuit 130 may determine a game score GS according to brightness information of the image data SD. In some embodiments, the target image 101 may be displayed via, but not limited to, an electronic screen 101A. Multiple concentric circle patterns are arranged on the target image 101, such that the image detection circuit 130 may determine the game score GS by analyzing the features of the concentric circles in the image data SD. This configuration will be explained below with reference to FIG. 4A and FIG. 4B. In some embodiments, the image detection circuit 130 may be implemented with at least one digital signal processing circuit with computing capability, but the present disclosure is not limited thereto. In other embodiments, the target image 101 may also be printed on physical paper.

The score broadcasting circuit 140 may be configured to broadcast the game score GS via a voice message. For example, the score broadcasting circuit 140 may include a voice processing circuit (not shown) and a speaker (not shown). The voice processing circuit may generate a corresponding voice message based on the game score GS and play the voice message through the speaker to inform the user of the current game score GS. The above-described configuration of the score broadcasting circuit 140 is given for illustrative purposes and the present disclosure is not limited thereto.

The data transmission circuit 150 is configured to transmit the game score GS to an external device 102. The external device 102 may be, but is not limited to, an electronic device such as a mobile phone, tablet, or computer, which may execute an application program to record and display the game score GS and other related information to the user. In some embodiments, the data transmission circuit 150 may be implemented with, but not limited to, a data transceiver circuit that connects to the external device 102 via a wireless network protocol 103. In some embodiments, the aforementioned wireless network protocol 103 may be, but is not limited to, a Bluetooth network protocol, a Wi-Fi network protocol, or another type of wireless transmission protocol.

The update circuit 160 is configured to generate an update signal SU and may transmit the update signal SU to the electronic screen 101A via the data transmission circuit 150 (or via another interface circuit or the external device 102), in order to update the target image 101 on the electronic screen 101A. With the above operation, the target image 101 that has already been shot may be replaced with a new target image 101. In some embodiments, the update circuit 160 is configured to detect a predetermined event to generate the update signal SU. In different embodiments, the predetermined event may include whether a number of trigger signals ST generated by the trigger device 110 is equal to a predetermined value TH, whether a vibration signal VS is detected, and/or whether an update command UCMD is received.

For example, the update circuit 160 may include a counter circuit (not shown), which counts based on the trigger signal ST to update a count value (which may indicate the number of the trigger signals ST generated by the trigger device 110), and generates the update signal SU when the count value is equal to the predetermined value TH, in order to update the target image 101. In some embodiments, the above operation may be understood as replacing the target image 101 with a new one when the number of times the shooting game device 100 has been played (or equivalently, the number of bullets available in a single game) reaches the upper limit. Alternatively, the update circuit 160 may include a gyroscope sensor (not shown) and a control circuit (not shown). The gyroscope sensor may be used to detect whether the shooting game device 100, through user operation, undergoes continuous vibration in a predetermined direction (e.g., but not limited to, up-and-down or left-and-right shaking), thereby generating the vibration signal VS. The control circuit may generate the update signal SU based on the vibration signal VS. In some embodiments, the above operation may be understood as using a specific gesture or shaking the shooting game device 100 to start a new round of the game. In some embodiments, the shooting game device 100 may be provided with a physical button (not shown) and a control circuit (not shown). The user may press the physical button to issue the update command UCMD, causing the control circuit to generate the update signal SU based on the update command UCMD. In some embodiments, the physical button mentioned above may be, but is not limited to, a reload button of the shooting game device 100. The various configurations of the update circuit 160 described above are given for illustrative purposes and the present disclosure is not limited thereto.

FIG. 2 illustrates a schematic external view of the shooting game device 100 in FIG. 1 according to some embodiments of the present disclosure. As shown in FIG. 2, the external form of the shooting game device 100 may be implemented as a toy gun. The image sensor circuit 120 may be mounted around a barrel 205 (or a scope) of the toy gun to capture images directed toward the target image 101. In some embodiments, after the image sensor circuit 120 is mounted, the sight position of the toy gun may be further calibrated, so that the sight position is correctly aligned within the image data SD generated by the image sensor circuit 120. Additionally, as previously mentioned, the magnetic element 110B may be arranged on or connected to the trigger 210 (which corresponds to the trigger component 110A in FIG. 1), so that it moves together with the trigger 210.

In different embodiments, the shooting game device 100 may take the form of various types of toy weapons, which may include, but are not limited to, toy guns, toy bows and arrows, toy slingshots, toy cannons, and so on. Therefore, it should be understood that the external appearance of the shooting game device 100 is not limited to that shown in FIG. 2, and all toy-based types of the shooting game devices 100 are within the contemplated scope of the present disclosure.

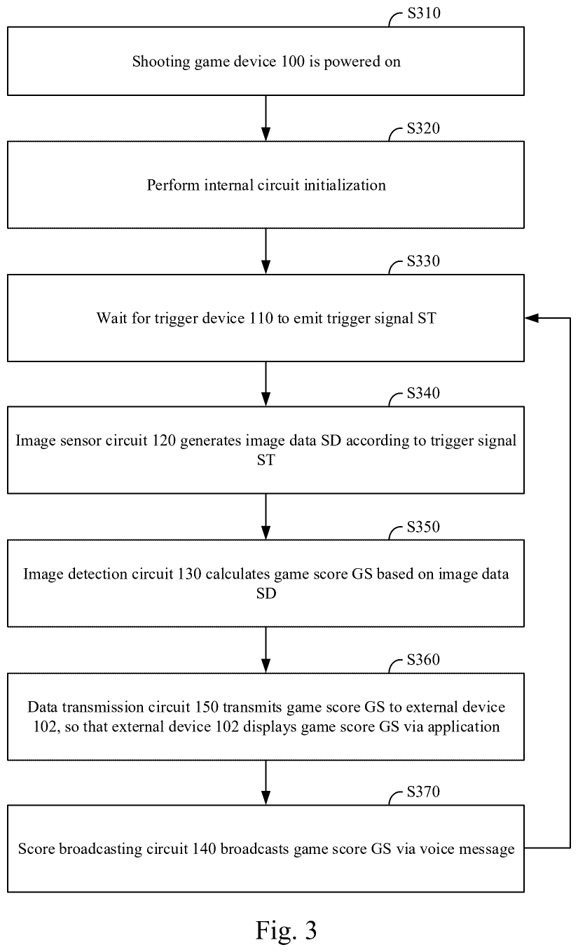

FIG. 3 illustrates a flowchart illustrating operations of the shooting game device 100 in FIG. 1 according to some embodiments of the present disclosure. In operation S310, the shooting game device 100 is powered on. In operation S320, internal circuit initialization is performed. For example, after the shooting game device 100 is powered on, multiple circuits within the shooting game device 100 (e.g., including the trigger device 110, the image sensor circuit 120, etc.) may perform initialization procedures to configure corresponding hardware parameters. In operation S330, the system waits for the trigger device 110 to emit a trigger signal ST, i.e., it waits for the user to operate the shooting game device 100 so that the trigger device 110 emits the trigger signal ST. In operation S340, the image sensor circuit 120 generates the image data SD according to the trigger signal ST. That is, in response to the user operation, the image sensor circuit 120 may capture an image directed toward the target image 101 to generate the image data SD. In operation S350, the image detection circuit 130 calculates the game score GS based on the image data SD. In operation S360, the data transmission circuit 150 transmits the game score GS to the external device 102, so that the external device 102 may display the game score GS via an application. In operation S370, the score broadcasting circuit 140 broadcasts the game score GS via a voice message. After the above operations are executed, operation S330 may be continued to wait for the next user operation.

The above operations are merely exemplary and are not limited to being performed in the sequence presented. Without departing from the operational methods and scope of the embodiments of the present disclosure, the above operations may be appropriately added, replaced, omitted, or executed in a different order. Alternatively, the above operations may be performed simultaneously or partially simultaneously.

FIG. 4A illustrates a flowchart illustrating the operations of the image detection circuit 130 in determining the game score GS according to some embodiments of the present disclosure. In operation S410, brightness information of the image data SD is extracted. For example, the image detection circuit 130 may extract brightness values from the image data SD (such as grayscale values or Y values in the YUV color space) to obtain the brightness information. In operation S420, a Hough transform is performed based on the brightness information to obtain a plurality of concentric circle features in the image data SD and a center point of the image data SD. In operation S430, the game score GS is determined according to the distance between a circle center point of the plurality of concentric circle features and the center point, and a maximum diameter among the plurality of concentric circle features.

In order to explain operation S420 and operation S430, reference is made to FIG. 4B, which illustrates a schematic diagram of the image data SD in FIG. 1 according to some embodiments of the present disclosure. As shown in FIG. 4B, since a plurality of concentric circles are arranged on the target image 101, multiple concentric circle patterns will also be present in the image data SD captured toward the target image 101. The image detection circuit 130 may perform a Hough transform based on the brightness information of the image data SD to detect multiple concentric circle features CR1 to CRn in the image data SD and obtain the center point CP of these concentric circle features. The outermost concentric circle feature CRn has a diameter R, which is the maximum diameter among the concentric circle features CR1 to CRn. In addition, the image detection circuit 130 may determine a distance d between the center point CP and a center point CC of the image data SD, and determine the game score GS according to the distance d and the maximum diameter R. In greater detail, the image detection circuit 130 may determine a reference distance as the product of a difficulty coefficient DC and the maximum diameter R (i.e., R2=R×DC, where R2 is the reference distance), and determine the game score GS according to the reference distance and the distance d. When the distance d is greater than the reference distance, the image detection circuit 130 may determine that the shot performed by the shooting game device 100 misses the target image 101 (i.e., off-target) and determines the game score GS to be 0. On the other hand, in some embodiments, when the distance d is not greater than the reference distance, the image detection circuit 130 may determine the game score GS based on the ratio of the difference between the reference distance and the distance d to the reference distance

$$( e . g . , GS = \frac{R 2 - d}{R 2} ) .$$

In some embodiments, when the distance d is less than or equal to the reference distance, the image detection circuit 130 may further determine the game score GS with the following equation:

$$GS = \frac{R 2 - d}{R 2} \times 10 + 0.9$$

In the above equation, the image detection circuit 130 calculates the ratio of the difference between the reference distance R2 and the distance d to the reference distance R2, multiplies the ratio by 10, and then adds 0.9 to determine the game score GS. As a result, the value of the game score GS is able to be limited within the range of 0-10.9, thereby making it more similar to actual shooting scores.

In some embodiments, the aforementioned difficulty coefficient DC is used to adjust the game difficulty. For example, the smaller the difficulty coefficient DC is, the lower the game score GS will be, which effectively increases the game difficulty; and vice versa. In some embodiments, the external device 102 may issue a command through an application program to the data transmission circuit 150 to configure the difficulty coefficient DC, and the data transmission circuit 150 may transmit the difficulty coefficient DC to the image detection circuit 130 to adjust the game difficulty. In other embodiments, the shooting game device 100 may be configured with other control button(s) to set the difficulty coefficient DC.

As described above, the shooting game device provided in some embodiments of the present disclosure may perform gameplay based on image detection and may determine the game score using only brightness information from the image data. This reduces the amount of data processing required for image detection and improves the efficiency of image processing, thereby enhancing the user experience.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications based on the claims of the present disclosure are all consequently viewed as being embraced by the scope of the present disclosure.

What is claimed is:

1. A shooting game device, comprising:
a trigger device configured to emit a trigger signal;
an image sensor circuit configured to capture image data of a target image in response to the trigger signal; and
an image detection circuit configured to determine a game score according to brightness information of the image data.

2. The shooting game device of claim 1, wherein the image detection circuit is configured to perform a Hough transform according to the brightness information of the image data to obtain a plurality of concentric circle features and a center point of the image data, and to determine the game score according to a first distance between a circle center point of the plurality of concentric circle features and the center point, and a maximum diameter among the plurality of concentric circle features.

3. The shooting game device of claim 2, wherein the image detection circuit is configured to determine a reference distance as a product of a difficulty coefficient and the maximum diameter, and to determine the game score according to the reference distance and the first distance, and the difficulty coefficient is used to adjust a game difficulty.

4. The shooting game device of claim 3, wherein when the first distance is not greater than the reference distance, the image detection circuit is further configured to determine the game score according to a ratio between a difference and the reference distance, wherein the difference is a difference between the reference distance and the first distance.

5. The shooting game device of claim 4, wherein the image detection circuit is further configured to multiply the ratio by 10 and add 0.9 to determine the game score.

6. The shooting game device of claim 3, wherein when the first distance is greater than the reference distance, the image detection circuit determines the game score to be zero.

7. The shooting game device of claim 1, further comprising:
a data transmission circuit configured to transmit the game score to an external device for displaying the game score.

8. The shooting game device of claim 7, wherein the data transmission circuit is configured to connect to the external device via a wireless network protocol.

9. The shooting game device of claim 8, wherein the wireless network protocol includes a Bluetooth network protocol or a Wi-Fi network protocol.

10. The shooting game device of claim 1, wherein a number of a Hall sensor in the trigger device is one.

11. The shooting game device of claim 1, wherein the target image is displayed via an electronic screen, and the shooting game device further comprises:
an update circuit configured to transmit an update signal to update the target image on the electronic screen.

12. The shooting game device of claim 11, wherein the update circuit is configured to detect a predetermined event to transmit the update signal.

13. The shooting game device of claim 12, wherein the predetermined event comprises whether a number of times the trigger device emits the trigger signal is equal to a predetermined value, whether a vibration signal is detected, or whether an update command is received.

14. The shooting game device of claim 1, further comprising:
a score broadcasting circuit configured to broadcast the game score via a voice message.

15. The shooting game device of claim 1, wherein the trigger device comprises:
a trigger component;
a magnetic element arranged on the trigger component; and
a Hall sensor configured to generate the trigger signal according to a magnetic field variation of the magnetic element when the trigger component moves.
